(19) United States
(12) Patent Application Publication
(10) Pub. No.: US 2003/0136742 A1
(43) Pub. Date: Jul. 24, 2003

(54) Wastewater treatment process using 8856 (A&B) to remove metals from wastewater

(76) Inventor: Ann Nahed Bersbach, Indianapolis, IN (US)

Correspondence Address: Ann N. Bersbach, 7653 Heatherdown Ct., Indianapolis, IN, 46259, US

(21) Appl. No.: 10/336,329

(22) Filed: Jan. 3, 2003

Related U.S. Application Data
(60) Provisional application No. 60/350,066, filed on Jan. 23, 2002.

(51) Int. Cl. C02F 1/52

(52) U.S. Cl. 210/724; 210/726

(57) ABSTRACT

The presented invention discloses a process to remove low or high concentrations of common or complexed heavy metals from aqueous solutions as well as oily solutions. The process uses a product (8856A), which is a mixture of 80% phosphoric acid (75-80%) and 20% aluminum sulfate (48%). The percentage of aluminum sulfate in 8856A is very critical in providing optimum solid-liquid separation in the settling stage and removing any excess phosphates from the discharge. Heavy metals such as iron, copper, nickel, zinc, chromium and lead are precipitated as metal phosphates. The process is capable of removing all of the metal in the solution because it discloses a longer detention time of two to four hours, which provides sufficient time to breakdown any complexing agents preventing precipitation of the metal. According to the presented invention, metal concentrations in the treated wastewater are decreased to levels below the detection limits.

### CROSS REFERENCE TO RELATED APPLICATIONS

Provisional Patent, Application No. 60/350,066—Filing Date: Jan. /23/2002, Confirmation No. 8003 Disclosure Document No. 504150

### STATEMENT REGARDING FEDERALLY SPONSORED RESEARCH OR DEVELOPMENT

Not Applicable

### REFERENCES TO SEQUENCE LISTING, A TABLE OR A COMPUTER PROGRAM LISTING COMPACT DISC APPENDIX

Not Applicable

### BACKGROUND OF THE INVENTION

The presented invention discloses a method to treat liquid industrial waste streams containing heavy metals such as copper, chromium, zinc, cadmium, nickel, iron and lead. Such solutions are frequently generated in manufacturing operations such as electroplating, metal finishing, iron and steel operations, printed circuit board production, paint manufacturing, processes that use oil solutions containing copper, processes that use organic dyes for anodizing, copper and nickel processing and petroleum refining residues. In these various applications, the process provides a procedure wherein inexpensive, readily accessible treatment chemicals are used to effectively remove heavy metals from solutions prior to discharge into publicly owned treatment facilities. City Ordinances and state and federal regulations preclude discharge of metals into the sewer systems or directly to any water stream.

Current trends in the effected industries are to lower the allowable levels of metal in the waste discharge. “The Environmental Protection Agency (EPA) is developing Effluent Limitations Guidelines, Pretreatment Standards, and New Source Performance Standards for the Metal Products & Machinery (MP & M) Point Source Category. This regulation, when finalized, will establish technology-based regulated limitations for wastewater discharge to navigable waters from MP & M facilities regulated by The National Pollutant Discharge Elimination System (NPDES) permitting program and will also establish pretreatment standards for the introduction of pollutants into Publicly Owned Treatment Works (POTWs) from MP & M facilities.

Signature Date for Proposed MP&M regulation: Oct. 31, 2000

Publication Date of Proposed Rule: Jan. 3, 2001

Signature Date for Final Action: Dec. 31, 2002”. From EPA website

“On Jan. 30, 2001 the USEPA held a workshop regarding MP&M rules at the AESF Week in Orlando Fla. Shari Barash, EPA's MP&M Project Manager and her assistant Michael Ebner gave the presentation. The USEPA has estimated that 10% of all Metal finishing shops will fail or go out of business as a result of MP&M implementation. Industry figures the number to be in the 20%-30% range. It has been promoted that MP&M's proposed effluent levels have been reduced by 50%-80% for those operations whose average discharge is 4000 gallons or more of water per day. The following is a comparison of some of the existing/proposed limits:

Section 413-4-day average-Vs the MP&M 30-day average.

Proposed limits for Nickel discharge are reduced from 2.6 ppm to 0.64 ppm.

Proposed chromium discharge limits have been reduced from 4.0 ppm to 0.55 ppm.

In the case of zinc, the reduction is from 2.6 ppm to 0.17 ppm”. From Craig Slanker—The American Electroplaters and Surface Finishers Society (AESF) Cincinnati Branch President.

There have been concerns that chemical substitution or other modification to the manufacturing process would be necessary to ultimately obtain lower metals concentrations in the discharge. However, extensive resources and study go into developing manufacturing process and even subtle changes to the manufacturing process can affect the finished product.

Traditional heavy metals wastewater treatments use lime or sodium hydroxide to precipitate heavy metals as metal hydroxides, which have a comparatively high solubility. Hydroxide precipitation removes metals present in low concentrations in solutions and is usually used to treat rinse waters. Different metals have different minimum solubilities at different pH levels. Hydroxide precipitates tend to resolublize (go back into solution) if the solution pH is either increased or decreased from the minimum solubility point of the metal, thereby reducing the removal efficiency. When treating waste streams containing two or more common metals (other than hexavalent chromium) with significantly different optimum pH levels, a two-stage operation is commonly used. First the wastewater is adjusted to the lowest desired pH level and the common metals are allowed to form precipitates and settle out by precipitation. Then the remaining wastewater is transferred to another tank and the pH is readjusted and the remaining common metals are allowed to form precipitates and settle out. Solutions containing hexavalent chromium are usually treated separately because hexavalent chromium must be reduced first to trivalent chromium before attempting hydroxide precipitation. Hexavalent chromium is often reduced to trivalent by the addition of sulfuric acid to lower the pH to 2.0 or 3.0 followed by adding sodium bisulfite. During this process sulfur dioxide gas is released.

Methods using hydroxide precipitation are incapable of precipitating complexed metals. Complexed metals are formed when common metals react with complexing agents such as ammonia, citrates, tartrates, quadrol, EDTA or hydrocarbon compounds. These complexing chemicals are commonly present in the solutions used in manufacturing processes. Complexed metals tend to remain in solution rather than form precipitates and settle out.

Moreover, hydroxide precipitation removes metals present only in low concentrations in the solutions. If the metals saturation increased for any reason, hydroxide precipitation fails to remove the excess metals, which results in violations of the National Pollutant Discharge Elimination System (NPDES) permits.

The result of hydroxide precipitation is a leachable hydrated sludge. This sludge is currently disposed as a hazardous waste due to the propensity for the metals to leach into the environment.

### BRIEF SUMMARY OF THE INVENTION

The presented invention addresses a method to treat industrial wastewater to remove heavy metals. The process uses a unique blend of phosphoric acid and aluminum sulfate (8856A) to precipitate metals. No previous patents mix phosphoric acid with any other chemicals prior to use in the treatment process. The purpose of aluminum sulfate, which is a coagulant, in 8856A is to remove any excess phosphates from the discharge and improve the solid liquid separation in the settling stage. The presented invention has the advantage of removing metals in low and high concentration, not only in aqueous solutions, but also in oily solutions with optimum removal of these metals. This is accomplished by allowing a longer reaction time than presented in existing methods. A detention time of at least two hours is critical in order to breakdown chemicals complexing the heavy metals and free these metals in the solution to be precipitated.

The objectives of the presented invention are as follows:

To provide a method of removing common heavy metals, even if present in high concentration in solutions, to levels below detection limits.

To provide a method of precipitating a variety of common heavy metals, such as iron, copper, zinc, chromium, lead and nickel in one step at one pH by adding a phosphoric acid based product 8856A.

To treat oily solutions containing heavy metals and achieve the same results, which is optimum removal of these metals.

To treat solutions containing complexed metals. This is accomplished by allowing a reaction time of at least two hours during precipitation. This detention time is critical to breakdown the chemicals combined with the metals and free these metals in the solution for precipitation.

To treat expended production fluids, such as acid baths and cleaner baths, as well as wash or rinse waters.

To generate an end product more stable and have less volume than the existing hydroxide processes. Captured metals are ultimately disposed of as metal phosphates, which have a lower propensity to leach metal into the environment and are generally less hydrated.

The presented invention is a process to remove low or high concentrations of heavy metals from aqueous solutions as well as oily solutions comprising the steps of:

(a) Adding product 8856A and allow to mix for two to four hours to precipitate metals

(b) Adding calcium chloride, a coagulant aid, to improve settleability and provide a source of calcium.

(c) Adding product 8856B as needed to adjust the pH to about 7.0 (permits limit for pH is usually 6.0-9.0)

(d) Adding polymer (flocculants) and dewater the sludge

### BRIEF DESCRIPTION OF THE DRAWING

FIG. 1 is a schematic diagram of the four steps comprising the treatment process of the presented invention.

### DETAILED DESCRIPTION OF THE INVENTION

The presented invention describes a method to remove heavy metals such as copper, zinc, chromium, iron and lead from waste streams containing common or complexed forms of these metals at any concentration. According to the presented invention, metal concentrations in the treated wastewater are decreased to levels below detection limits.

As with the current practice for waste streams containing cyanide, the presented process requires the removal of cyanide prior to treatment for heavy metals. A one-stage process is effective for this pre-treatment.

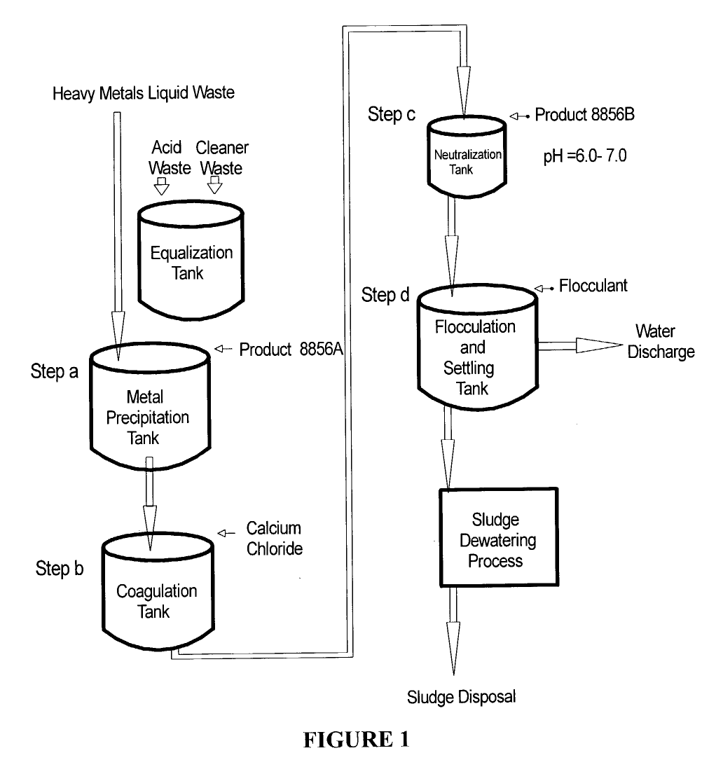

The process of the presented invention is explained by reference to the illustrated schematic of FIG. 1.

The process uses two proprietary components, material 8856A and 8856B. Material 8856A is comprised of 70-80% phosphoric acid (part 8856A-1) and an aqueous solution containing 48% aluminum sulfate (part 8856A-2). Material 8856A is a mixture of 80% 8856A-1 and 20% 8856A-2, by volume. Material 8856B is an aqueous solution containing 45% sodium hydroxide and 5% potassium hydroxide, by weight. Potassium hydroxide is an inert ingredient to prevent freezing of 8856B, and may be substituted by an equal weight of sodium hydroxide.

The following is a description of the steps involved in the process:

Step a) The first step in the process is the precipitation of metals. Heavy metal wastes are received in the precipitation tank and mixed with product 8856A as illustrated in FIG. 1. Concentrated solutions, such as cleaners and acid bath solutions, are equalized in the equalization tank and are sent gradually to the precipitation tank to mix with the heavy metal wastes and product 8856A. The reaction time ranges from two to four hours depending on the contents of the solution in the precipitation tank. The reaction time is vital in the metals removal process. During this time chemical bonds that complex the metals are destroyed and the metals are released in the solution and ultimately complexed as a phosphate compound. The long detention time ensures the removal of all metals from the solution. The amount of 8856A must be sufficient to precipitate all the metals and complexing agents. Experiments showed that two gallons of 8856A per six thousand gallons of waste is the sufficient amount. It is important to point out that the reaction time is more critical than the amount of chemical used.

Step b) Calcium chloride addition is preferably used between about 0.75 and about 1.5 g/L. Stirring is typically continued for about 10 minutes during which time coagulation occurs. The addition of a calcium source has several beneficial effects, including that any excess phosphoric acid used in the previous step will now be precipitated as calcium phosphate.

Step c) The next step is pH adjustment. In this step, 8856B (described above) is used to increase the pH to at least 6.0 preferably 7.0. The purpose of this step is to adjust the pH according to the NPDES pH requirements, which is usually a pH of 6.0 to 9.0.

Step d) After pH adjustment the mixture is treated by flocculants and allowed to settle. Various flocculants may be used, preferably anionic polymers. The flocculent is typically added at between 5 ppm and about 100 ppm, depending on the solid concentration and the nature of the solid. The mixture is then allowed to settle for about 1 to 2 hours in the clarifiers.

I claim:

1. A process to remove low or high concentrations of metals from aqueous solutions as well as oily solutions comprising the steps of:
a. Adding product 8856A, made of 80% phosphoric acid (75%-80%) and 20% aluminum sulfate (48%), in the amount of two gallons of 8856A per six thousand gallons of liquid waste and allowing to mix for two to four hours
b. Adding calcium chloride, a coagulant aid to improve settleability and provide a source of calcium to precipitate any excess phosphoric acid used in step (a) as calcium phosphate.
c. Adding product 8856B made of 45% sodium hydroxide and 5% potassium hydroxide as needed to adjust the pH to about 7.0 (permits limit for pH is usually 6.0-9.0)
d. Adding polymer (flocculants) and dewater the sludge

2. The process of claim 1, wherein product 8856A is used to precipitate the metals in Step (a)

3. The process of claim 1, wherein 8856A is a mixture of two components.

4. The process of claim 1, wherein 80% of 8856A is phosphoric acid (75-80%)

5. The process of claim 1, wherein 20% of 8856A is aluminum sulfate (48%).

6. The process of claim 1, wherein the constituents of 8856A are critical and the information is not inferred in any other patents.

7. The process of claim 1, wherein no previous patents mix phosphoric acid with any other chemicals prior to use in the treatment process.

8. The process of claim 1, wherein about two gallons of 8856A is used for every six thousand gallons of liquid waste.

9. The process of claim 1, wherein the detention time in step (a) is 2-4 hours.

10. The process of claim 1, wherein 8856A reacts for at least two hours with heavy metal liquid wastes containing complexed metals, breaking down complexing agents such as hydrocarbons, hydrochlorides, nitrogen compounds or any other chelators that prevent precipitation of the metals, releasing the metals in the common form and making possible the complete precipitation of these metals.

11. The process of claim 1, wherein calcium chloride, a coagulant aid is added in step (c) to improve settleability and precipitate any excess phosphoric acid as calcium phosphate.

12. The process of claim 1, wherein product 8856B is used to adjust the pH to 6.0 or preferably 7.0.

13. The process of claim 1, wherein product 8856B is made of two components.

14. The process of claim 1, wherein the first component in 8856B is sodium hydroxide at a concentration of 45%

15. The process of claim 1, wherein the second component in 8856B is potassium hydroxide at a concentration of 5%.

16. The process of claim 1, wherein the final pH is kept between 6.0 and 7.0

17. The process of claim 1, wherein metals are removed from oily solutions as well as aqueous solutions.

18. The process of claim 1, wherein concentrated acid and cleaner bath solutions are treated along with heavy metal wastes in step (a).

19. The process of claim 1, wherein heavy metals are removed from solutions containing low or high concentrations of these metals.
